(19) United States
(12) Patent Application Publication
(10) Pub. No.: US 2010/0081060 A1
(43) Pub. Date: Apr. 1, 2010

(54) ELECTROLYTE AND LITHIUM SECONDARY BATTERY USING THE SAME

(75) Inventor: NORIO IWAYASU, HITACHINAKA (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: SHIN-KOBE ELECTRIC MACHINERY CO., LTD.

(21) Appl. No.: 12/551,915

(22) Filed: Sep. 1, 2009

(30) Foreign Application Priority Data
Sep. 26, 2008 (JP) 2008-247057

(51) Int. Cl. H01M 6/14

(52) U.S. Cl. 429/303

(57) ABSTRACT

A polymerizable composition for electrochemical devices contains a polymerizable compound of Formula 1 and a polymerizable compound of Formula 2, wherein “x” is an integer of 4 to 6; “m” is an integer of 1 to 10; and R is a lower alkyl group. The composition is polymerized to provide a polymer, and the polymer is used in an electrolyte to provide a gel electrolyte. The gel electrolyte has a high degree of swelling with electrolytic solution and thereby shows a high ionic conductivity.

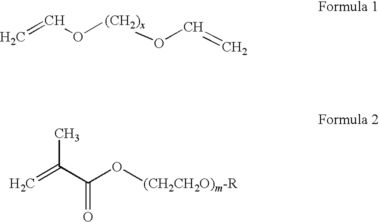

### CLAIM OF PRIORITY

The present application claims priority from Japanese Patent application serial No. 2008-247057, filed on Sep. 26, 2008, the content of which is hereby incorporated by reference into this application.

### BACKGROUND OF THE INVENTION:

1. Field of the Invention

The present invention relates to a gel electrolyte that has a high ionic conductivity and excels in thermal stability; and to a lithium secondary battery using the gel electrolyte.

2. Description of Related Art

Lithium secondary batteries have high energy densities and are thereby widely used typically in notebook computers and mobile phones. The application of them as power sources of electric cars has also been examined, as such electric cars have recently receive attention from a viewpoint of preventing global warming due to increased carbon dioxide.

The lithium secondary batteries have used liquid electrolytic solutions as electrolytes. However, when stored over a long period of time, batteries using such liquid electrolytic solutions can suffer from leakage of the electrolytic solutions due typically to deterioration of a cladding material, and leaked electrolytic solutions can damage apparatus.

To avoid this, gel electrolytes prepared through gelation of electrolytic solutions have been developed. The gel electrolytes are broadly grouped under physically cross-linked gel electrolytes and chemically cross-linked gel electrolytes. The physically cross-linked gel electrolytes are prepared by mixing an electrolytic solution with a polymer such as a polyvinylidene fluoride (PVDF) or polyacrylonitrile (PAN), dissolving the polymer in the electrolytic solution through heating, and cooling the resulting solution, and thereby forming a gel, as disclosed in Document 1 (Japanese Patent Laid-open No. 2002-334690) and Document 2 (Japanese Patent Laid-open No. 2003-317692).

However, because the physically cross-linked gel electrolytes require heating for the dissolution of the polymer and the polymer solution has a high viscosity, it is difficult to uniformly form gel electrolytes between electrodes when the physically cross-linked gel electrolytes are applied to batteries. Additionally, when the formed gel is exposed to high temperature, the polymer and the electrolytic solution may separate from each other and thereby the gel structure may be destroyed.

In contrast, because chemically cross-linked gel electrolytes excel in a thermal stability and can have a variety of properties by the combination of material monomers, they are promising electrolytes.

The chemically cross-linked gel electrolytes, however, have a low ionic conductivity. Such chemically cross-linked gel electrolytes are derived from across-linked polymer swollen or impregnated with an electrolytic solution. The cross-linked polymer is prepared from a monomer having two or more polymerizable functional groups (multifunctional monomer) and a monomer having one polymerizable functional group (monofunctional monomer). In order to improve ionic conduction of chemically cross-linked gel electrolytes, it is effective to increase the amount of the electrolytic solution which the cross-linked polymer can hold (a degree of swelling with an electrolytic solution). A specific process or device for increasing the degree of swelling with the electrolytic solution of a cross-linked polymer has not yet been found, and it is highly desirable to develop a cross-linked polymer having a high degree of swelling with the electrolytic solution.

### SUMMARY OF THE INVENTION

After intensive investigations, we have found that a cross-linked polymer prepared from a multifunctional monomer of following Formula 1 and a monofunctional monomer of following Formula 2 has a specifically high degree of swelling with an electrolytic solution. In Formula 1, “x” is an integer of 4 to 6; and in Formula 2, “m” is an integer of 1 to 10; and R is a lower alkyl group.

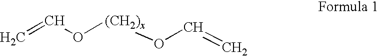

The gel electrolyte according to the present invention

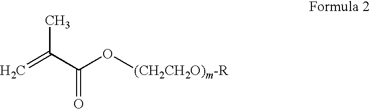

which contains the cross-linked polymer derived from the specific multifunctional monomer and the specific monofunctional monomer can have a high degree of swelling with the electrolytic solution and can thereby have a high ionic conductivity.

Further objects, features and advantages of the present invention will become apparent from the following description of the preferred embodiments with reference to the attached drawings.

### BRIEF DESCRIPTION OF THE DRAWINGS

FIG. 1 is a perspective view of a process for assembling a lithium secondary battery according to an embodiment of the present invention.

FIG. 2 is a top view of the lithium secondary battery according to the embodiment of the present invention.

### EXPLANATION OF REFERENCE NUMERALS

1: Positive Electrode, 2: Separator, 3: Negative Electrode, 4: Aluminum Laminate, 5: Lead of Positive Electrode, 6: Lead of Negative Electrode, 7: Thermal Sealed Part.

### DETAILED DESCRIPTION OF THE PREFERRED EMBODIMENTS:

Some embodiments of the present invention will be illustrated hereinafter. All numbers herein are assumed to be modified by the term “about.”

As used herein a “multifunctional monomer” refers a compound of Formula 1, in which “x” is an integer of 4 to 6.

As used herein a “monofunctional monomer” refers to a compound of Formula 2, in which “m” is an integer of 1 to 10; and R is a lower alkyl group. The lower alkyl group contains carbon atoms the number of which is 1 to 5 and is preferably methyl group or ethyl group.

The molar ratio of the monofunctional monomer to the multifunctional monomer [(monofunctional monomer)/(multifunctional monomer)] is generally 1 to 200, preferably 50 to 150, and more preferably 90 to 120. Effects of the present invention tend to be lowered when the molar ratio is excessively large or excessively small.

A gel electrolyte according to the present invention is prepared by forming a cross-linked polymer from the multifunctional monomer and the monofunctional monomer, and swelling the cross-linked polymer with an electrolytic solution. The gel electrolyte can also be prepared by polymerizing a composition containing an electrolytic solution and monomer components for constituting a cross-linked polymer. The cross-linked polymer herein preferably at least contains a structure of following Formula 3, but is not limited to this structure:

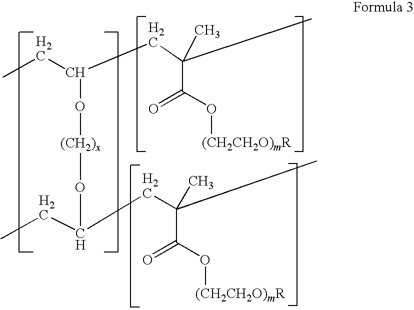

The preparation of the cross-linked polymer can be performed by adding a polymerization initiator to a polymerizable composition containing a multifunctional monomer and a monofunctional monomer, and polymerizing the resulting composition through heating. A radical polymerization initiator, for example, may be used as the polymerization initiator, and the polymerization may be performed at a temperature within a generally employed range for a generally employed polymerization duration. A radical polymerization initiator having a 10-hour half-life temperature of about 30° C. to 90° C. is preferred, in order to avoid deterioration of members used in the electrochemical device. The 10-hour half-life temperature is an index of temperature and rate of decomposition. The 10-hour half-life temperature refers to such a temperature that the amount of the radical polymerization initiator becomes one half that of the initial radical polymerization initiator before dissolution when such a radical polymerization initiator as benzene is dissolved in an amount of 0.01 mole/liter in a solvent inert to free radicals, and left stand for 10 hours. The amount of the polymerization initiator herein is generally 0.1 to 10 percent by weight, and preferably 0.3 to 5 percent by weight, relative to the polymerizable composition including the multifunctional monomer and monofunctional monomer.

Exemplary radical polymerization initiators include organic peroxides such as t-butyl peroxypivalate, t-hexyl peroxypivalate, methyl ethyl ketone peroxide, cyclohexanone peroxide, 1,1-bis(t-butylperoxy)-3,3,5-trimethylcyclohexane, 2,2-bis(t-butylperoxy)octane, n-butyl 4,4-bis(t-butylperoxy)valerate, t-butyl hydroperoxide, cumene hydroperoxide, 2,5-dimethylhexane-2,5-dihydroperoxide, di-t-butyl peroxide, t-butyl cumyl peroxide, dicumyl peroxide, α,α′-bis(t-butylperoxy-m-isopropyl)benzene, 2,5-dimethyl-2,5-di(t-butylperoxy)hexane, 2,5-dimethyl-2,5-di(t-butylperoxy)hexane, benzoyl peroxide, and t-butyl peroxyisopropyl carbonate; and azo compounds such as 2,2′-azobisisobutyronitrile, 2,2′-azobis (2-methylbutyronitrile), 2,2′-azobis (4-methoxy-2,4-dimethylvaleronitrile), 2,2′-azobis (2,4-dimethylvaleronitrile), 1,1′-azobis(cyclohexane-1-carbonitrile), 2-(carbamoylazo)isobutyronitrile, 2-phenylazo-4-methoxy-2,4-dimethyl-valeronitrile, 2,2-azobis (2-methyl-N-phenylpropionamidine)dihydrochloride, 2,2′-azobis[N-(4-chlorophenyl)-2-methylpropionamidine]dihydrochloride, 2,2′-azobis[N-hydroxyphenyl]-2-methylpropionamidine]dihydrochloride, 2,2′-azobis[2-methyl-N-(phenylmethyl)propionamidine]dihydrochloride, 2,2′-azobis[2-methyl-N-(2-propenyl)propionamidine]dihydrochloride, 2,2′-azobis (2-methylpropionamidine)dihydrochloride, 2,2′-azobis[N-(2-hydroxyethyl)-2-methylpropionamidine]dihydrochloride, 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl) propane]dihydrochloride, 2,2′-azobis[2-(5-hydroxy-3,4,5,6-tetrahydropyrimidin-2-yl)propane]dihydrochloride, 2,2′-azobis{2-[1-(2-hydroxyethyl)-2-imidazolin-2-yl]propane}dihydrochloride, 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis[2-methyl-N-(2-hydroxyethyl)propionamide], 2,2′-azobis (2-methylpropionamide)dihydrate, 2,2′-azobis (2,4,4-trimethylpentane), 2,2′-azobis (2-methylpropane), dimethyl 2,2′-azobisisobutylate, 4,4′-azobis (4-cyanovaleric acid), and 2,2′-azobis[2-(hydroxymethyl)propionitrile].

An “electrolytic solution” in the present invention refers to a solution of a supporting electrolyte in a nonaqueous solvent. The nonaqueous solvent is not especially limited, as long as the supporting electrolyte is soluble therein, but preferred examples thereof include organic solvents such as diethyl carbonate, dimethyl carbonate, ethylene carbonate, ethyl methyl carbonate, propylene carbonate, γ-butyrolactone, tetrahydrofuran, and dimethoxyethane. Each of different nonaqueous solvents can be used alone or in combination.

The supporting electrolyte in the present invention is not especially limited, as long as being soluble in the nonaqueous solvent, but preferred examples thereof include electrolytic salts such as LiPF₆, LiN(CF₃SO₂)₂, LiN(C₂F₆SO₂)₂, LiClO₄, LiBF₄, LiAsF₆, LiI, LiBr, LiSCN, Li₂B₁₀Cl₁₀, and LiCF₃CO₂. Each of different supporting electrolytes can be used alone or in combination.

The present invention will be illustrated in further detail with reference to several examples below. It should be noted, however, these examples are never intended to limit the scope of the present invention. Preparation of samples, measurement of degree of swelling, and evaluation of battery properties in the examples were performed all in an argon atmosphere. The examples and comparative examples are listed in Table 1 below.

[Degree of Swelling with Electrolytic Solution]

A prepared sample polymer was immersed in an electrolytic solution, and the weight of the polymer 24 hours later was measured. The degree of swelling was determined by dividing the weight of the polymer after swelling (impregnation) by the weight of the polymer before swelling.

[Measurement of Ionic Conductivity]

The ionic conductivity was measured by interposing a sample electrolyte between two stainless steel electrodes at 25° C. to form an electrochemical cell; applying an alternating current between the two electrodes and measuring a resistance component according to the alternating current impedance method; and calculating the ionic conductivity from a real impedance intercept in a Cole-Cole plot.

[Preparation of Electrodes]

[Positive Electrode]

A mixture of 80 percent by weight of CELLSEED (trade name of a lithium cobalt oxide supplied by Nippon Chemical Industrial Co., Ltd.), 10 percent by weight of SP270 (trade name of a graphite supplied by Nippon Graphite Industries, Ltd.), and 10 percent by weight of KF1120 (trade name of a polyvinylidene fluoride supplied by Kureha Corporation) was prepared, and the mixture was poured into N-methyl-2-pyrrolidone and mixed to form a slurry solution. The slurry mixture was applied in an amount of 150 g/m² to an aluminum foil of 20 μm thickness by the doctor blade method, followed by drying. The foil bearing the applied slurry was pressed so as to attain a balk density of the slurry of 3.0 g/cm³, and was cut to a piece 1 cm wide and 1 cm long to form a positive electrode.

[Negative Electrode]

A mixture of 90 percent by weight of CARBOTRON PE (trade name of an amorphous carbon supplied by Kureha Corporation) and 10 percent by weight of KF1120 (trade name of a polyvinylidene fluoride supplied by Kureha Corporation) was prepared, and the mixture was poured into N-methyl-2-pyrrolidone and mixed to form a slurry solution. The slurry was applied in an amount of 70 g/m² to a copper foil of 20 μm thickness by the doctor blade method, followed by drying. The foil bearing the applied slurry was pressed so as to attain a balk density of the slurry of 1.0 g/cm³, and was cut to a piece 1.2 cm wide and 1.2 cm long to form a negative electrode.

[Preparation of Battery]

A sample battery was prepared by inserting a solid electrolyte swollen with an electrolytic solution into between the above-prepared positive electrode and negative electrode, and packaging them with an aluminum laminate cell as a packaging material.

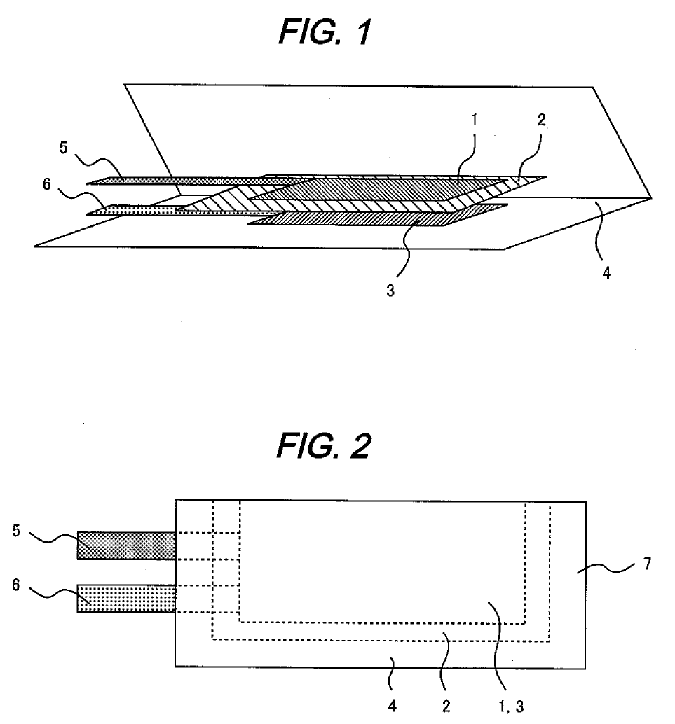

FIG. 1 is a perspective view of a process for assembling a lithium secondary battery according to an embodiment of the present invention. FIG. 2 is atop view of the lithium secondary battery according to the embodiment of the present invention.

As shown in FIG. 1, a separator 2 (an electrolyte) is interposed between a positive electrode 1 and a negative electrode 3. Further, an aluminum laminate 4 that is folded interposes the positive electrode 1, the negative electrode 3 and the separator 2. Leads 5 and 6 are respectively added to the positive electrode 1 and the negative electrode 3.

As shown in FIG. 2, a thermal sealed part 7 is formed between the folded aluminum laminate 4 in an edge thereof, and thereby the positive electrode 1, the negative electrode 3 and the separator 2 are covered.

[Conditions for Charge and Discharge of Battery]

Charge and discharge operations were performed at 25° C. at a current density of 0.5 mA/cm² using a charge/discharge evaluation device (under the trade name of TOSCAT-3000 supplied by Toyo System Co., Ltd.). Specifically, charge at a constant current was performed to a voltage of 4.1 V; and charge at a constant voltage was performed for 12 hours after the voltage reached 4.1 V. Next, discharge at a constant current was performed to a discharge final voltage of 3.0 V. The capacity as obtained after the first discharge was defined as an initial charge/discharge capacity. While a pair of charge and discharge operations performed under the above conditions was set as one cycle, the charge and discharge operations were repeated until the capacity reached 80% or less of the initial charge/discharge capacity and the number of cycles was defined as a cycle life. Independently, a constant-current charge was performed at a current density of 1 mA/cm² to a voltage of 4.1 V, and a charge at a constant voltage was performed for 12 hours after the voltage reached 4.1V. Next, a discharge at a constant current was performed to a discharge final voltage of 3.0 V. The ratio of the resulting capacity to the initial charge/discharge capacity was determined as a high-rate charge/discharge property.

### EXAMPLE 1

A monomer composition was prepared by mixing a multifunctional monomer of Formula 1 (x=4) and a monofunctional monomer of Formula 2 (m=2) in a molar ratio of the former to the latter of 1:100 and adding thereto PERHEXYL PV (supplied by NOF Corporation) as a polymerization initiator in an amount of 0.3 percent by weight of the total weight of the monomers. The monomer composition was poured into a polytetrafluoroethylene boat, held at 60° C. for 3 hours, and thereby yielded a polymer. The prepared polymer at least partially has a structure of Formula 3:

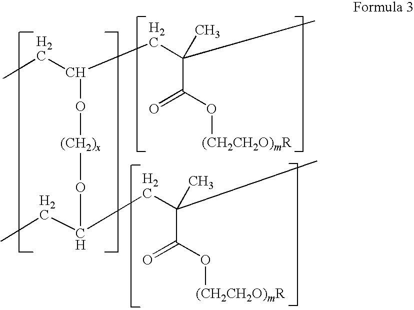

The polymer was impregnated with an electrolytic solution (a solvent: 1:1:1 (by volume) mixture of ethylene carbonate, dimethyl carbonate and diethyl carbonate; an electrolytic salt: LiN(C₂F₆SO₂)₂ at an electrolytic salt concentration of 0.9 mol/kg (solvent)) and left stand at room temperature for 20 hours. After impregnation, the polymer was recovered and weighed, and the degree of swelling with the electrolytic solution was determined to find to be 8.0. This gel electrolyte (polyelectrolyte) had an ionic conductivity of 3.0 mS/cm. The battery was found to have an initial charge/discharge capacity of 2 mAh, a cycle life of 75 cycles, and a high-rate charge/discharge property of 97%.

### EXAMPLE 2

A monomer composition was prepared by mixing a multifunctional monomer (x=5) and a monofunctional monomer (m=2) in a molar ratio of the former to the latter of 1:100. A polyelectrolyte was prepared by the procedure of Example 1, except for using the above-prepared monomer composition. The degree of swelling with electrolytic solution and ionic conductivity of the polyelectrolyte were determined; and a battery was prepared using the polyelectrolyte and properties thereof were evaluated by the procedure of Example 1. As a result, the polyelectrolyte was found to have a degree of swelling with electrolytic solution of 7.5 and an ionic conductivity of 2.8 mS/cm. The battery was found to have an initial charge/discharge capacity of 2 mAh, a cycle life of 75 cycles, and a high-rate charge/discharge property of 95%.

### EXAMPLE 3

A monomer composition was prepared by mixing a multifunctional monomer (x=6) and a monofunctional monomer (m=2) in a molar ratio of the former to the latter of 1:100. A polyelectrolyte was prepared by the procedure of Example 1, except for using the above-prepared monomer composition. The degree of swelling with electrolytic solution and ionic conductivity of the polyelectrolyte were determined; and a battery was prepared using the polyelectrolyte and properties thereof were evaluated by the procedure of Example 1. As a result, the polyelectrolyte was found to have a degree of swelling with electrolytic solution of 7.3 and an ionic conductivity of 2.7 mS/cm. The battery was found to have an initial charge/discharge capacity of 2 mAh, a cycle life of 75 cycles, and a high-rate charge/discharge property of 93%.

### EXAMPLE 4

A monomer composition was prepared by mixing a multifunctional monomer (x=4) and a monofunctional monomer (m=1) in a molar ratio of the former to the latter of 1:100. A polyelectrolyte was prepared by the procedure of Example 1, except for using the above-prepared monomer composition. The degree of swelling with electrolytic solution and ionic conductivity of the polyelectrolyte were determined; and a battery was prepared using the polyelectrolyte and properties thereof were evaluated by the procedure of Example 1. As a result, the polyelectrolyte was found to have a degree of swelling with electrolytic solution of 7.5 and an ionic conductivity of 2.8 mS/cm. The battery was found to have an initial charge/discharge capacity of 2 mAh, a cycle life of 75 cycles, and a high-rate charge/discharge property of 95%.

### EXAMPLE 5

A monomer composition was prepared by mixing a multifunctional monomer (x=4) and a monofunctional monomer (m=5) in a molar ratio of the former to the latter of 1:100. A polyelectrolyte was prepared by the procedure of Example 1, except for using the above-prepared monomer composition. The degree of swelling with electrolytic solution and ionic conductivity of the polyelectrolyte were determined; and a battery was prepared using the polyelectrolyte and properties thereof were evaluated by the procedure of Example 1. As a result, the polyelectrolyte was found to have a degree of swelling with electrolytic solution of 7.2 and an ionic conductivity of 2.6 mS/cm. The battery was found to have an initial charge/discharge capacity of 2 mAh, a cycle life of 75 cycles, and a high-rate charge/discharge property of 93%.

### EXAMPLE 6

A monomer composition was prepared by mixing a multifunctional monomer (x=4) and a monofunctional monomer (m=10) in a molar ratio of the former to the latter of 1:100. A polyelectrolyte was prepared by the procedure of Example 1, except for using the above-prepared monomer composition. The degree of swelling with electrolytic solution and ionic conductivity of the polyelectrolyte were determined; and a battery was prepared using the polyelectrolyte and properties thereof were evaluated by the procedure of Example 1. As a result, the polyelectrolyte was found to have a degree of swelling with electrolytic solution of 7.0 and an ionic conductivity of 2.5 mS/cm. The battery was found to have an initial charge/discharge capacity of 2 mAh, a cycle life of 75 cycles, and a high-rate charge/discharge property of 93%.

### EXAMPLE 7

A monomer composition was prepared by mixing a multifunctional monomer (x=4) and a monofunctional monomer (m=2) in a molar ratio of the former to the latter of 1:10. A polyelectrolyte was prepared by the procedure of Example 1, except for using the above-prepared monomer composition. The degree of swelling with electrolytic solution and ionic conductivity of the polyelectrolyte were determined; and a battery was prepared using the polyelectrolyte and properties thereof were evaluated by the procedure of Example 1. As a result, the polyelectrolyte was found to have a degree of swelling with electrolytic solution of 3.5 and an ionic conductivity of 1.3 mS/cm. The battery was found to have an initial charge/discharge capacity of 2 mAh, a cycle life of 60 cycles, and a high-rate charge/discharge property of 78%.

### EXAMPLE 8

A monomer composition was prepared by mixing a multifunctional monomer (x=4) and a monofunctional monomer (m=2) in a molar ratio of the former to the latter of 1:200. A polyelectrolyte was prepared by the procedure of Example 1, except for using the above-prepared monomer composition. The degree of swelling with electrolytic solution and ionic conductivity of the polyelectrolyte were determined; and a battery was prepared using the polyelectrolyte and properties thereof were evaluated by the procedure of Example 1. As a result, the polyelectrolyte was found to have a degree of swelling with electrolytic solution of 7.5 and an ionic conductivity of 2.8 mS/cm. The battery was found to have an initial charge/discharge capacity of 2 mAh, a cycle life of 75 cycles, and a high-rate charge/discharge property of 93%.

### COMPARATIVE EXAMPLE 1

A monomer composition was prepared by mixing ethylene glycol dimethacrylate (DM) as a multifunctional monomer with di(ethylene glycol)methyl ether methacrylate (DEGMEM) as a monofunctional monomer in a molar ratio of the former to the latter of 1:100, and adding thereto PERHEXYL PV (supplied by NOF Corporation) as a polymerization initiator in an amount of 0.3 percent by weight of the total weight of the monomers. The monomer composition was poured into a polytetrafluoroethylene boat, held at 60° C. for 3 hours, and thereby yielded a polymer. The polymer was impregnated with an electrolytic solution (solvent: 1:1:1 (by volume) mixture of ethylene carbonate, dimethyl carbonate, and diethyl carbonate; electrolytic salt: LiN(C₂F₆SO₂)₂ at an electrolytic salt concentration of 0.9 mol/kg (solvent)) and left stand at room temperature for 20 hours. After swelling, the polymer was recovered and weighed, and the degree of swelling with electrolytic solution was determined to find to be 3.4. The resulting polyelectrolyte had an ionic conductivity of 1.1 mS/cm. A battery was prepared using the polyelectrolyte and found to have an initial charge/discharge capacity of 1.7 mAh, a cycle life of 30 cycles, and a high-rate charge/discharge property of 60%.

### COMPARATIVE EXAMPLE 2

A monomer composition was prepared by mixing ethylene glycol dimethacrylate (DM) as a multifunctional monomer with methyl methacrylate (MMA) as a monofunctional monomer in a molar ratio of the former to the latter of 1:100, and adding thereto PERHEXYL PV (supplied by NOF Corporation) as a polymerization initiator in an amount of 0.3 percent by weight of the total weight of the monomers. The monomer composition was poured into a polytetrafluoroethylene boat, held at 60° C. for 3 hours, and thereby yielded a polymer. The polymer was impregnated with an electrolytic solution (solvent: 1:1:1 (by volume) mixture of ethylene carbonate, dimethyl carbonate, and diethyl carbonate; electrolytic salt: LiN(C₂F₆SO₂)₂ at an electrolytic salt concentration of 0.9 mol/kg (solvent)) and left stand at room temperature for 20 hours. After swelling, the polymer was recovered and weighed, and the degree of swelling with electrolytic solution was determined to find to be 1.3. The resulting polyelectrolyte had an ionic conductivity of 0.05 mS/cm. A battery was prepared using the polymer as a polyelectrolyte, but it had an excessively high internal resistance and could not be charged and discharged.

TABLE 1

| | Cross-linked polymer | | | | | | | |
|---|---|---|---|---|---|---|---|---|
| | | | Ratio of | Gel electrolyte | | | | |
| | | | monofunctional | Degree of | | Battery evaluations | | |
| | Multi- | Mono- | monomer to | swelling | Ionic | Initial discharge | | High rate |
| | functional | functional | multifunctional | with electrolytic | conductivity | capacity | | charge/discharge |
| Examples | monomer x | monomer m | monomer | solution | (mScm⁻¹) | (mAh) | Cycle life (cycle) | property (%) |
| 1 | 4 | 2 | 100 | 8.0 | 3.0 | 2.0 | 75 | 97 |
| 2 | 5 | 2 | 100 | 7.5 | 2.8 | 2.0 | 75 | 95 |
| 3 | 6 | 2 | 100 | 7.3 | 2.7 | 2.0 | 75 | 93 |
| 4 | 4 | 1 | 100 | 7.5 | 2.8 | 2.0 | 75 | 95 |
| 5 | 4 | 5 | 100 | 7.2 | 2.6 | 2.0 | 75 | 93 |
| 6 | 4 | 10 | 100 | 7.0 | 2.5 | 2.0 | 75 | 93 |
| 7 | 4 | 2 | 10 | 3.5 | 1.3 | 1.7 | 60 | 78 |
| 8 | 4 | 2 | 200 | 7.5 | 2.8 | 2.0 | 75 | 93 |
| Comparative | DM | DEGMEM | 100 | 3.4 | 1.1 | 1.7 | 30 | 60 |
| Example 1 | | | | | | | | |
| Comparative | DM | MMA | 100 | 1.3 | 0.05 | Unmeasurable | Unmeasurable | Unmeasurable |
| Example 2 | | | | | | | | |

What is claimed is:

1. A polymerizable composition for electrochemical devices, comprising:
a polymerizable compound represented by following Formula 1; and
a polymerizable compound represented by following Formula 2: 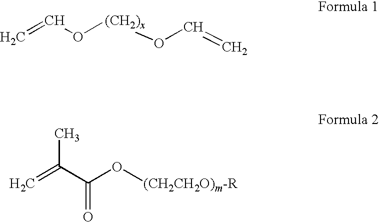
wherein “x” is an integer of 4 to 6; “m” is an integer of 1 to 10; and R is a lower alkyl group.

2. The polymerizable composition according to claim 1, wherein a molar ratio of the polymerizable compound of Formula 2 to the polymerizable compound of Formula 1 is 1 to 200.

3. A polyelectrolyte for electrochemical devices, comprising a polymer as a polymerization product of the polymerizable composition of claim 2.

4. The polyelectrolyte according to claim 3, further comprising an electrolytic salt and a nonaqueous solvent.

5. The polyelectrolyte according to claim 4, wherein the electrolytic salt comprises at least one member selected from the group consisting of LiPF₆, LiN(CF₃SO₂)₂, LiN(C₂F₆SO₂)₂, LiClO₄, LiBF₄, LiAsF₆, LiI, LiBr, LiSCN, Li₂B₁₀Cl₁₀ and LiCF₃CO₂.

6. The polyelectrolyte according to claim 4, wherein the nonaqueous solvent comprises at least one member selected from the group consisting of diethyl carbonate, dimethyl carbonate, ethylene carbonate, ethyl methyl carbonate, propylene carbonate, γ-butyrolactone, tetrahydrofuran and dimethoxyethane.

7. A lithium secondary battery comprising:
a positive electrode capable of occluding and releasing lithium ions;
a negative electrode capable of occluding and releasing lithium ions; and
an electrolyte interposed between the positive electrode and the negative electrode,
the electrolyte containing a polymer as a polymerization product of a polymerizable compound represented by following Formula 1 and a polymerizable compound represented by following Formula 2: 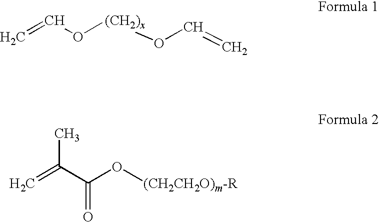
wherein “x” is an integer of 4 to 6; “m” is an integer of 1 to 10; and R is a lower alkyl group.

8. The lithium secondary battery according to claim 7, wherein the molar ratio of the polymerizable compound of Formula 2 to the polymerizable compound of Formula 1 is 1 to 200.

9. A polyelectrolyte for electrochemical devices, constituted from a polymerizable composition including a multifunctional monomer and a monofunctional monomer,
at least partially containing a structure represented by following Formula 3:

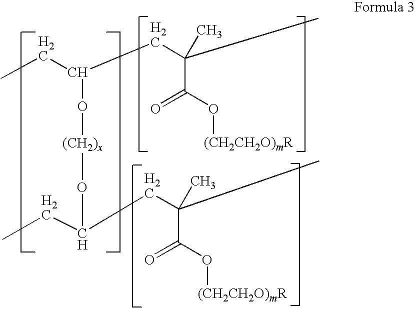

10. The polyelectrolyte according to claim 9, wherein a molar ratio of the monofunctional monomer to the multifunctional monomer is 50 to 150.

11. A lithium secondary battery comprising:
a positive electrode capable of occluding and releasing lithium ions;
a negative electrode capable of occluding and releasing lithium ions; and
an electrolyte interposed between the positive electrode and the negative electrode,
the electrolyte at least partially containing a structure represented by following Formula 3: [chemical structure]
